(19) United States
(12) Patent Application Publication
(10) Pub. No.: US 2026/0244213 A1
(43) Pub. Date: Aug. 20, 2026

(54) MOTION CONTROL OF A VEHICLE BASED ON ARTIFICIAL FLOW GUIDANCE

(71) Applicant: VOLVO TRUCK CORPORATION, Göteborg (SE)

(72) Inventors: Yangyan GAO, Palo Alto, CA (US); Timothy GORDON, Lincoln, Lincolnshire (GB); Shammi RAHMAN, Lincoln, Lincolnshire (GB); Aria NOORI ASIABAR, Buckingham (GB); Leo LAINE, Härryda (SE)

(73) Assignee: VOLVO TRUCK CORPORATION, Göteborg (SE)

(21) Appl. No.: 19/469,801

(22) PCT Filed: Mar. 29, 2023
(86) PCT No.: PCT/EP2023/058141

§ 371 Date: Sep. 26, 2025

(51) Int. Cl. G05D 1/646

(52) U.S. Cl. CPC G05D 1/646

(57) ABSTRACT

A plurality of tracking points are defined in relation to the vehicle. A method includes using AFG to determine a target acceleration value for each tracking point, and determining a desired acceleration value for each tracking point based on the target acceleration values and on a structural constraint between the tracking points. The method also includes causing motion control of the vehicle based on the desired acceleration values. In some examples, the method includes limiting the target acceleration value by application of a target acceleration saturation threshold.

### CROSS-REFERENCE TO RELATED APPLICATIONS

This application is a U.S. National Stage application of PCT/EP2023/058141, filed Mar. 29, 2023 and published on Oct. 3, 2024, as WO 2024/199648, all of which is hereby incorporated by reference in its entirety.

### TECHNICAL FIELD

The disclosure relates generally to vehicle control, such as control associated with vehicle motion management (VMM). In particular aspects, the disclosure relates to motion control of a vehicle based on artificial flow guidance (AFG). The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Many applications for vehicle control uses a representation of a vehicle, wherein the representation is defined via a point (a.k.a. particle) in space that represents the position of the vehicle. For example, path-following algorithms, such as pure pursuit and artificial flow guidance (AFG), determine a desired movement (e.g., speed and direction) of a particle that represents the vehicle position, and control the vehicle based on the desired movement. Generally, path-following algorithms may be useful for implementing autonomous, or semi-autonomous, driving.

Rahman Shammi, et al., “Improved Lateral Performance of a Long Combination Vehicle Based on Artificial Flow Guidance”, Proceedings of the 27th Symposium of the International Association of Vehicle System Dynamics describes an approach for improved lateral performance of a long combination vehicle, where tracking points are used in relation to multiple steerable axes and a PID feedback control is applied to reduce the error between reference and actual path.

Even though representation of vehicle position via a tracking point generally provides an efficient approach for vehicle control, inferior vehicle behavior is not always avoided. For example, in various scenarios, the vehicle control may suffer from one or more of the following problems: slow convergence to a desired path, oscillation behavior in relation to the desired path, poor ability to stay on the desired path, etc.

Therefore, there is a need for alternative ways perform path-following vehicle control.

### SUMMARY

According to a first aspect of the disclosure, a computer system comprises processing circuitry. The computer system is for motion control of a vehicle based on artificial flow guidance (AFG) in relation to a reference path, wherein a plurality of tracking points are defined in relation to the vehicle. The processing circuitry is configured to use AFG to determine a target acceleration value for each tracking point, determine a desired acceleration value for each tracking point based on the target acceleration values and on a structural constraint between the tracking points, and cause motion control of the vehicle based on the desired acceleration values.

Typically, the location of a tracking point may be defined in relation to a vehicle unit. For example, the location of a tracking point may be defined along a longitudinal axis of a vehicle unit.

The first aspect of the disclosure may seek to improve motion control of the vehicle. Technical benefits may include faster convergence to a desired path compared to other approaches, less oscillation behavior in relation to the desired path compared to other approaches, improved ability to stay on the desired path compared to other approaches, etc.

In some examples, including at least one preferred example, the processing circuitry is configured to cause the motion control of the vehicle by transforming the desired acceleration values to desired global motion parameters for vehicle motion management.

A technical benefit may include that actuator requests may be based on global motion parameters, while satisfying desired motion behavior at each of the tracking points.

In some examples, including at least one preferred example, the processing circuitry is configured to determine the desired acceleration values sequentially, starting from a specific one of the tracking points in an initial determination step. The initial determination step comprises determining the desired acceleration value of the specific tracking point as the target acceleration value for the specific tracking point. Each further determination step comprises determining the desired acceleration value of a considered one of the tracking points based on the target acceleration value for the considered tracking point, the desired acceleration value determined for a respective tracking point in a previous determination step, and the structural constraint between the respective tracking point and the considered tracking point.

A technical benefit may include that the desired motion behaviors of the tracking points are translated so that they can be gathered into a collective statement regarding desired motion.

In some examples, including at least one preferred example, each target acceleration value relates to a target speed and a target curvature. Then, the initial determination step may be conditioned on compliance with target speed and target curvature for the specific tracking point, and each further determination step may be conditioned on compliance with target curvature (and not on compliance with target speed) for the considered tracking point.

A technical benefit may include that the desired motion behaviors of the tracking points are translated under the constraint that different points on the vehicle have the same speed.

In some examples, including at least one preferred example, the processing circuitry is configured to determine the target acceleration value of a particular tracking point by acquiring an AFG velocity reference for the particular tracking point, and determining a flow acceleration for the particular tracking point based on a gradient of the AFG velocity reference at the particular tracking point.

A technical benefit may include that the AFG velocity reference is converted to a parameter (acceleration) that is particularly suitable for translation along the vehicle.

In some examples, including at least one preferred example, the processing circuitry is configured to determine the gradient of the AFG velocity reference by application of a two-dimensional curvilinear coordinate system defined for a reference point on the reference path.

A technical benefit may include that the gradient computation may be implemented with lower complexity compared to other approaches.

In some examples, including at least one preferred example, the curvilinear coordinate system has a first basis along the reference path and a second basis perpendicular to the first basis, and magnitudes of the first and second bases are related by a scaling value in a Cartesian coordinate system. For example, the scaling value may be a function of an arc curvature of the reference path at the reference point and on a lateral displacement of the particular tracking point from the reference point.

A technical benefit may include that the impact of a parameter component which is tangential to the reference path may be varied (e.g., in relation to a parameter component which represents lateral displacement from the reference path).

In some examples, including at least one preferred example, the processing circuitry is configured to determine the target acceleration value of a particular tracking point by adjusting the flow acceleration for the particular tracking point using AFG feedback.

A technical benefit may include that imperfections of the implementation may be mitigated.

In some examples, including at least one preferred example, the processing circuitry is configured to limit the AFG feedback by application of an AFG feedback saturation threshold, and/or to limit the target acceleration value by application of a target acceleration saturation threshold.

A technical benefit may include that the vehicle motion control can avoid abrupt motion changes.

According to a second aspect of the disclosure, a vehicle is provided, which comprises the computer system of the first aspect.

The second aspect of the disclosure may seek to provide a vehicle configured for improved motion control compared to other approaches.

According to a third aspect of the disclosure, a computer-implemented method is provided, for motion control of a vehicle based on artificial flow guidance (AFG) in relation to a reference path, wherein a plurality of tracking points are defined in relation to the vehicle. The method comprises using (by processing circuitry of a computer system) AFG to determine a target acceleration value for each tracking point, determining (by the processing circuitry) a desired acceleration value for each tracking point based on the target acceleration values and on a structural constraint between the tracking points, and causing (by the processing circuitry) motion control of the vehicle based on the desired acceleration values.

The third aspect of the disclosure may seek to improve motion control of the vehicle. Technical benefits may include faster convergence to a desired path compared to other approaches, less oscillation behavior in relation to the desired path compared to other approaches, improved ability to stay on the desired path compared to other approaches, etc.

According to a fourth aspect of the disclosure, a computer program product is provided. The computer program product comprises program code for performing, when executed by the processor device, the method of the third aspect.

The fourth aspect of the disclosure may seek to convey program code for motion control of a vehicle based on AFG in relation to a reference path. A technical benefit may include that new vehicles and/or legacy vehicles may be conveniently configured, by software installation/update, to perform the method of the third aspect.

According to a fifth aspect of the disclosure, a non-transitory computer-readable storage medium is provided. The non-transitory computer-readable storage medium comprises instructions, which when executed by a processor device, cause the processor device to perform the method of the third aspect.

The fifth aspect of the disclosure may seek to convey program code for motion control of a vehicle based on AFG in relation to a reference path. A technical benefit may include that new vehicles and/or legacy vehicles may be conveniently configured, by software installation/update, to perform the method of the third aspect.

In some examples, any of the above aspects may additionally have features identical with or corresponding to any of the various features as explained above for any of the other aspects.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a schematic drawing of a vehicle according to some examples.

FIG. 2 is a flow chart of a method for motion control of a vehicle based on AFG according to some examples.

FIG. 3 is a schematic block diagram of a vehicle motion control system according to some examples.

FIG. 4 is a schematic block diagram of vehicle motion management according to some examples.

FIG. 5 is a schematic drawing of a vector field for path following based on vector field guidance according to some examples.

FIG. 6 is a schematic drawing illustrating a path following approach based on vector field guidance according to some examples.

FIG. 7 is a schematic drawing illustrating acceleration values according to some examples.

FIG. 8 is a schematic drawing illustrating acceleration values according to some examples.

FIG. 9 is a schematic drawing illustrating a two-dimensional curvilinear coordinate system in relation to a reference path according to some examples.

FIG. 10 is a schematic block diagram illustrating an apparatus for motion control of a vehicle based on AFG according to some examples.

FIG. 11 is a schematic diagram of a computer system according to some examples.

FIG. 12 is a schematic drawing of a computer readable medium according to some examples.

FIG. 13 is a schematic block diagram of a control unit according to some examples.

### DETAILED DESCRIPTION

The detailed description set forth below provides information and examples of the disclosed technology with sufficient detail to enable those skilled in the art to practice the disclosure.

Generally, it should be noted that when the term “vehicle” is used herein, it may refer to a vehicle that comprises two or more vehicle units (where a vehicle unit may, for example, consist of a rigid vehicle part), or to a vehicle comprising a single vehicle unit.

In the following, enhanced motion control of a vehicle based on artificial flow guidance (AFG) in relation to a reference path will be exemplified by use of a plurality of tracking points defined in relation to the vehicle. A point in space that represents the position of a vehicle, or a vehicle unit, may be referred to as a “tracking point”. For example, there may be defined at least one tracking point per vehicle unit.

The motion control of the vehicle may be improved by using a plurality of tracking points, since the use of multiple tracking points provides for more elaborate vehicle motion control, which in turn enables—for example—improved stability of the vehicle during motion maneuvers and/or improved path-following behavior.

For example, a tractor unit and a trailer unit may each have a respective tracking point so that a respective target motion may be determined for each of the two units, wherein the respective target motion is specific to the tracking point location of the considered vehicle unit. The target motion may, for example, be for controlling the vehicle unit, as represented by the tracking point, in relation to a desired path.

Alternatively or additionally, a vehicle unit may have two or more tracking points associated with it (e.g., one close to a front end of the vehicle unit and one close to a rear end of the vehicle unit), and a respective target motion may be determined for each of the tracking points, wherein the respective target motion is specific to the location of the considered tracking point. The target motion may, for example, be for controlling the vehicle unit portion represented by the tracking point in relation to a desired path.

Since a vehicle unit is typically a rigid (or semi-rigid) body, and since different vehicle units are typically connected to each other in a way that—at least to some extent—hinders them from moving independently of each other, there is typically a kinetic inter-relation between the plurality of tracking points. Approaches are also exemplified herein to account for the kinetic inter-relation between the tracking points in the motion control process, wherein the kinetic inter-relation between the tracking points is represented as a structural constraint between the tracking points.

It should be noted that the suggested approaches are compatible with conventional vehicles (e.g., combination vehicles with active steering only for the front axle, and possibly passive steering for subsequent vehicle axes/units), as well as with more elaborate vehicles (e.g., combination vehicles with multi-axle steering).

Thus, the suggested approaches may provide a unified model with distributed reference motion relating to all parts of an articulated vehicle (including long combination vehicles).

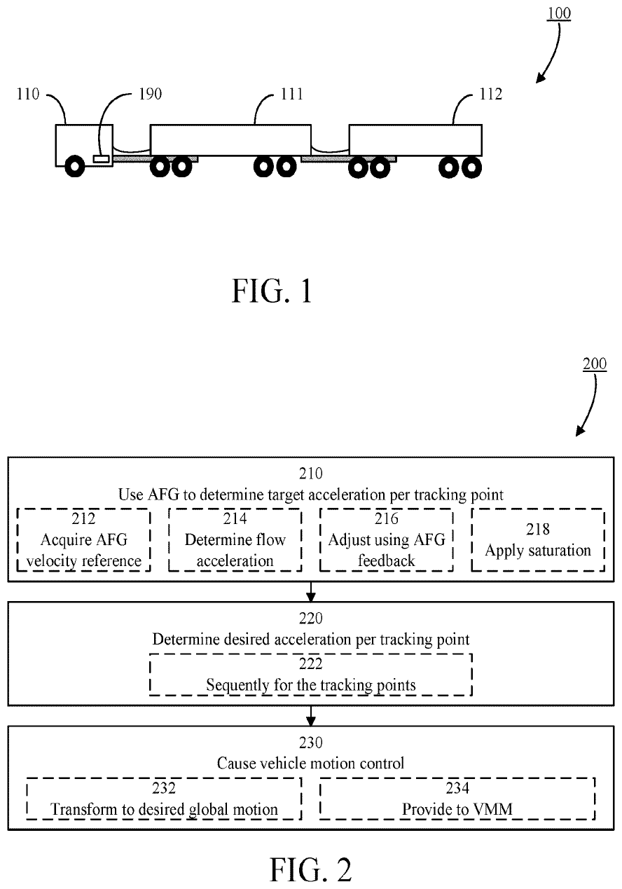

FIG. 1 is a schematic drawing of a vehicle 100 for cargo transport where the herein disclosed techniques can be applied with advantage. The vehicle 100 comprises a truck or towing vehicle 110 configured to tow one or more trailer units 111, 112 in a known manner. The example tractor 110 comprises a vehicle control unit (VCU) 190 configured to perform various vehicle control functions, such as path following and vehicle motion management. One or more of the trailer unit(s) 111, 112 may optionally also comprise a VCU (not shown). The vehicle 100 may, optionally, be connected via wireless link to a remote server (not shown), which comprises a control unit. The techniques disclosed herein may be performed by any of these control units, or by a combination of one or more of these control units. An on-board VCU 190 may also be parameterized by the remote server 150. The remote server, may, for example, be a cloud server, a server of a vehicle control system, or any other suitable server.

FIG. 2 illustrates an example method 200 for motion control of a vehicle based on artificial flow guidance (AFG) in relation to a reference path. The method 200 is a computer-implemented method, and is performed by processing circuitry of a computer system. For example, the method 200 may be performed by the VCU 190 of FIG. 1.

As illustrated by step 210, the method 200 comprises using AFG to determine a target acceleration value α^{p} for each tracking point of a plurality of tracking points defined in relation to the vehicle.

Generally, a tracking point is a representation of the position of the vehicle (or vehicle unit, or portion of vehicle unit). For example, the location of the tracking point may be defined relative a vehicle(-unit)-centric coordinate system. Alternatively or additionally, the location of the tracking point may be defined along a longitudinal axis of the vehicle (unit). In a typical example with a first coordinate axis along the longitudinal direction of the vehicle (unit) and a second coordinate axis along the lateral direction of the vehicle (unit), the tracking point location may be defined by coordinates (x,0), where x defines the location of the tracking point along a longitudinal axis of the vehicle (unit).

As illustrated by optional sub-step 212, step 210 may comprise acquiring an AFG velocity reference for each tracking point (e.g., represented by a location-specific guiding vector w). Then, the target acceleration values α^{p} may be determined based on the velocity references.

For example, sub-step 212 may comprise receiving the AFG velocity reference from another unit configured to provide velocity requests based on a tracking point, a desired path, and an AFG path-following algorithm. Alternatively, sub-step 212 may comprise determining the AFG velocity reference based on a tracking point, a desired path, and a path-following algorithm.

As illustrated by optional sub-step 214, step 220 may—alternatively or additionally—comprise determining a flow acceleration α^{f} for each tracking point. Then, the target acceleration values α^{p} may be determined based on the flow accelerations.

For example, sub-step 214 may comprise determining the flow acceleration by receiving it from another unit configured to provide acceleration requests based on a tracking point, a desired path, and an AFG path-following algorithm. Alternatively, sub-step 214 may comprise determining the flow acceleration based on a gradient (e.g., the derivative) of the AFG velocity reference at the tracking point (e.g., according to α^{f}=\dot{w}=δw/δt). According to some examples, the flow acceleration may be determined as α^{f}=(w·∇)w. Alternatively, a finite difference approximation may be used to determine the flow acceleration; α_{f}(x)=(w(x+hw(x))−w(x))/h, where the parameter h has a relatively small number, such as 0.001.

According to some examples, the flow acceleration α^{f} for a tracking point may be used directly as the target acceleration value α^{p} for that tracking point; α^{p}=α^{f}.

According to some examples, as illustrated by optional sub-step 216, the flow acceleration α^{f} for a tracking point may be adjusted using an AFG feedback indicating an acceleration error α^{e}. Then, it may be used to determine the target acceleration value α^{p} for that tracking point; e.g., α^{p}=α^{f}+α^{e}.

Generally, the acceleration error a^{e} may be any suitable feedback value. For example, the acceleration error may be determined as α^{e}=−k(ν−w), where ν indicates the current velocity at the tracking point. Other examples include using a nonlinear feedback equation, or defining the acceleration error via desired body sideslip angles.

According to some examples, as illustrated by optional sub-step 218, the target acceleration value α^{p} and/or the acceleration error α^{e} for a tracking point may be limited by application of a respective saturation threshold; e.g.,

$${a}^{p} = \{ \begin{matrix}{a}_{max}^{p} & if \vert {a}_{max}^{p} \vert < \vert {a}_{raw}^{p} \vert \\ {a}_{raw}^{p} & if \vert {a}_{min}^{p} \vert < \vert {a}_{raw}^{p} \vert \leq \vert {a}_{max}^{p} \vert \\ {a}_{min}^{p} & if \vert {a}_{raw}^{p} \vert < \vert {a}_{min}^{p} \vert\end{matrix}$$

$${a}^{e} = \{ \begin{matrix}{a}_{max}^{e} & if \vert {a}_{max}^{e} \vert < \vert {a}_{raw}^{e} \vert \\ {a}_{raw}^{e} & if \vert {a}_{min}^{e} \vert < \vert {a}_{raw}^{p} \vert \leq \vert {a}_{max}^{e} \vert \\ {a}_{min}^{e} & if \vert {a}_{raw}^{e} \vert < \vert {a}_{min}^{e} \vert\end{matrix}$$

where

$${a}_{max}^{p}$$

$$and$$

$${a}_{min}^{p}$$

exemplify a target acceleration saturation threshold,

$${a}_{max}^{e}$$

$$and$$

$${a}_{min}^{e}$$

exemplify and AFG feedback saturation threshold,

$${a}_{raw}^{e}$$

represents an acceleration error before the limitation

$$( e . g . , {a}_{raw}^{e} = - k ( v - w ) ) ,$$

$$and$$

$${a}_{raw}^{p}$$

represents a target acceleration value before the limitation

$$( e . g . , {a}_{raw}^{p} = {a}^{f} or {a}_{raw}^{p} = {a}^{f} + {a}^{e} ) .$$

According to some examples,

$${a}_{min}^{p} = - {a}_{max}^{p}$$

$$and$$

$${a}_{min}^{e} = - {a}_{max}^{e} .$$

Some typical values are

$${a}_{max}^{p} = 3 m / {s}^{2}$$

$$and$$

$${a}_{max}^{e} = 0.5 m / {s}^{2}$$

The limitations may, for example, be beneficial for avoiding excessively large acceleration requests and/or to mitigate instability problems (e.g., lower the rollover probability).

As illustrated by step 220, the method 200 also comprises determining a desired acceleration value α^{d} for each tracking point. The desired acceleration is based on the target acceleration values and on a structural constraint between the tracking points.

Thus, step 210 primarily handles parameters for each of the tracking points in isolation, while step 220 considers parameters of the tracking points based on their inter-relation.

The structural constraint(s) between tracking points may generally represent a kinetic inter-relation between the tracking points. Generally, any suitable structural constraint may be applied.

For example, when a vehicle unit has two or more tracking points associated with it (e.g., when the vehicle unit is a rigid body), the structural constraint between the tracking points may be based on one or more of a distance constraint, a velocity constraint, and an acceleration constraint.

An example distance constraint comprises the condition that the distance between the tracking points is fixed, i.e., (x_{A}-x_{B}) (x_{A}-x_{B})=const, where x_{A} and x_{B} represent the respective two-dimensional positions of the tracking points.

An example velocity constraint comprises using a translation point where the side-slip is assumed to the zero (i.e., the lateral component of the velocity ν_{T} at the translation point is assumed to be zero). The translation point may be found based on vehicle kinematics and/or current operating conditions of the vehicle. For example, the translation point may correspond to a non-steered wheel axle. Thus, the translation may comprise using

$${v}_{A , y} = ( \frac{l}{L} ) {v}_{B , y} + ( 1 - \frac{l}{L} ) {v}_{T , y} = ( \frac{l}{L} ) {v}_{B , y}$$

for the lateral component and using a unit value (e.g., ν_{A,x}=ν_{B,x}=1) for the longitudinal component, wherein l represents the longitudinal distance between tracking point A and the translation point, L represents the longitudinal distance between tracking point B and the translation point, and ν_{A} and ν_{B} represent the respective velocities of the tracking points A and B.

An example acceleration constraint comprises α_{A,x}=α_{B,x}−ω²Λ for the longitudinal component and α_{A,y}=α_{B,x}−\dot{ω}Λ for the lateral component, wherein A represents the longitudinal distance between the tracking points A and B, ω represents the moment of the vehicle unit, and α_{A} and α_{B} represent the respective accelerations of the tracking points A and B.

When a tractor unit and a trailer unit each has a respective tracking point, the structural constraint between the tracking points may be based on the location of the physical connection point between the tractor unit and the trailer unit (and possibly on a maximum angle between the tractor unit and the trailer unit), as well as on physical constraint(s) between each tracking point and the physical connection point; e.g., as exemplified above.

As illustrated by optional sub-step 222, step 220 may comprise determining the desired acceleration values sequentially for the tracking points; starting from a specific one of the tracking points in an initial determination step, and then processing one tracking point after another in respective further determination steps. When for tracking points on different vehicle units, the physical connection point between the vehicle units may be introduced as an additional (intermediate) tracking point to be processed.

Generally, the tracking points may be processed in any suitable order. In a typical example, the tracking points are processed in an order of occurrence starting from the front end of the vehicle (i.e., the initial determination step relates to a front-most tracking point). Alternatively, the tracking points may be processed in an order of occurrence starting from the rear end of the vehicle. Yet alternatively, the initial determination step may relate to a tracking point which is neither closest to the front end of the vehicle nor closest to the rear end of the vehicle. In the latter case, the other tracking points may be processed—e.g., in parallel—in two groups (one group comprising the tracking points in front of the tracking point of the initial determination step, and another group comprising the rest of the tracking points); in an order of occurrence starting from the tracking point of the initial determination step, for example.

For example, sub-step 222 may comprise, for the initial determination step, determining the desired acceleration value of the specific tracking point as the target acceleration value for the specific tracking point; i.e.,

$${a}_{0}^{d} = {a}_{0}^{p} ,$$

where the index “0” represents the tracking point considered in the initial determination step.

Alternatively or additionally, sub-step 222 may comprise, for a (e.g., each) further determination step, determining the desired acceleration value

$${a}_{i}^{d}$$

of a considered tracking point based on the target acceleration value

$${a}_{i}^{p}$$

for the considered tracking point, the desired acceleration value

$${a}_{i - 1}^{d}$$

determined for a respective tracking point in a previous determination step, and the structural constraint between the respective tracking point and the considered tracking point, where the index “i”, i=1, 2, 3, . . . represents the tracking point considered in the i^{th} determination step.

For example, for two tracking points related by rigid body constraints (e.g., two tracking points on a same vehicle unit), the desired acceleration value

$${a}_{i}^{d}$$

for a further determination step may be determined via a two-dimensional equation system, wherein one equation expresses a rigid body constraint (e.g., a distance constraint, a velocity constraint, or an acceleration constraint), and the other equation expresses a one-dimensional target movement for the considered tracking point i.

According to some examples, each target acceleration value

$${a}_{i}^{p}$$

relates to two-dimensional movement (e.g., a target speed and a target curvature). The initial determination step may be conditioned on compliance with both movement dimensions (e.g., target speed and target curvature) for the specific tracking point; e.g., manifested by

$${a}_{0}^{d} = {a}_{0}^{p} .$$

A (e.g., each) further determination step may be conditioned on compliance with (only) one of the movement dimensions (e.g., target curvature) for the considered tracking point. This condition may be used to construct the equation that expresses the one-dimensional target movement for the considered tracking point i.

For two tracking points which are not related by rigid body constraints (e.g., two tracking points on different vehicle units which are movably connected to each other), an intermediate tracking point (e.g., a connection point between the vehicle units) may be introduced, which relates to each of the two tracking points by rigid body constraints, and the same principles may be applied as exemplified above for two tracking points related by rigid body constraints.

As illustrated by step 230, the method 200 also comprises causing motion control of the vehicle based on the desired acceleration values.

In some examples, step 230 may comprise transforming the desired acceleration values to desired global motion parameters for vehicle motion management, as illustrated by optional sub-step 232. For example, the global motion parameters may include global desired acceleration elements, such as a desired longitudinal acceleration

$${a}_{x , G}^{d} ,$$

a desired lateral acceleration

$${a}_{y , G}^{d} ,$$

and a desired angular acceleration

$${\ddot{ψ}}_{j}^{d}$$

for each vehicle unit, wherein

$${ψ}_{j}^{d}$$

denotes desired yaw of vehicle unit j. Alternatively or additionally, the global motion parameters may include global forces elements ν, such as a desired longitudinal force

$${F}_{x}^{d} ,$$

a desired lateral force

$${F}_{y}^{d} ,$$

and a desired moment

$${M}_{j}^{d}$$

for each vehicle unit j.

In some examples, step 230 may comprise providing the desired acceleration values and/or the desired global motion parameters to another processing unit configured to perform the motion control (e.g., a vehicle motion management, VMM, function), as illustrated by optional sub-step 234. For example, the other processing unit may be configured to transform the desired acceleration values to desired global motion parameters, and apply the global motion parameters for vehicle motion management.

In some examples, step 230 may comprise performing at least part of the motion control.

Generally, the motion control may be performed according to any suitable approach based on the desired acceleration values and/or the desired global motion parameters. For example, the motion control may be performed based on a motion control approach that uses global motion parameters as input values.

The use of acceleration values—not (only) velocity values—when handling multiple tracking points may be beneficial because acceleration is associated with global forces elements, which may be used to control the motion of a vehicle. Thus, using acceleration values provides for compatibility with control allocation (CA) methods, and potential complexity reduction when such methods are applied (especially in relation to articulated/multi-unit vehicles). Conventional CA methods typically generate virtual controls based on a simplified/reference vehicle model and optimization of an objective function, which may be computational costly and/or yield a non-converging solution. Using the approaches presented herein may be beneficial to mitigate such problems. For example, the proposed AFG multipoint acceleration target approach typically removes the need for a dynamic reference model; thereby simplifying the overall CA.

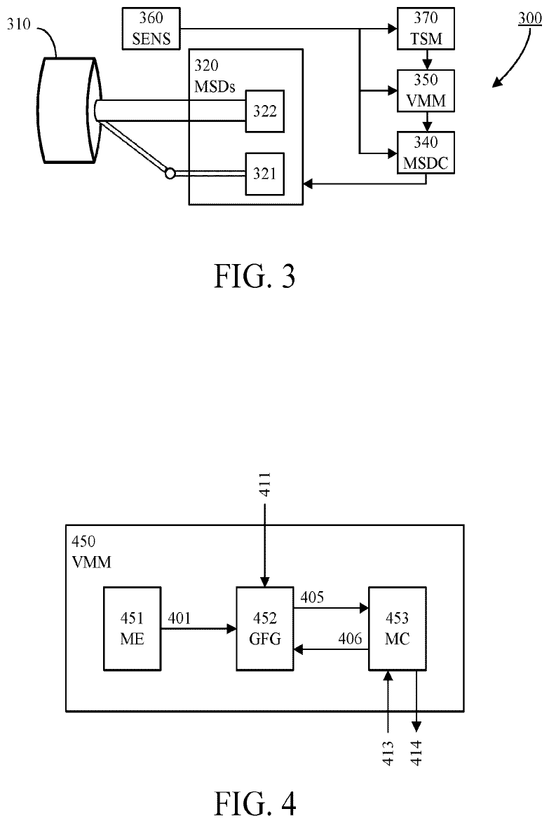

FIG. 3 schematically illustrates functionality 300 for controlling a wheel 310 (e.g., on the tractor 110 of FIG. 1) by some example motion support devices (MSDs) 320; here comprising a power steering arrangement 321 and a propulsion device 322 such as an electric machine (EM). The power steering arrangement 321 and the propulsion device 322 are examples of actuators which can be controlled by one or more MSD control units (CNTR) 340.

A traffic situation management (TSM) function 370 plans driving operations with a time horizon (e.g., 1-10 seconds or so). This time frame may correspond to, for example, the time it takes for the vehicle to negotiate a curve. The vehicle maneuvers, planned and executed by the TSM, can be associated with acceleration profiles and curvature profiles which describe a desired vehicle movement (e.g., velocity and turning) for a given maneuver. The TSM may continuously request the desired acceleration profiles and curvature profiles from a vehicle motion management (VMM) function 350 which performs force allocation to meet the requests from the TSM in a safe and robust manner and communicates requests to the different MSDs. Typically, the VMM function 350 manages both force generation and MSD coordination (i.e., it may determine what forces that are required at the vehicle units in order to fulfil the requests from the TSM function 370, for instance to accelerate the vehicle according to a requested acceleration profile requested by TSM and/or to generate a certain curvature motion by the vehicle also requested by TSM). The forces may comprise e.g., yaw moments, longitudinal forces, and lateral forces, as well as different types of torques to be applied at different wheels.

The MSD control unit 340, the VMM function 350, and the TSM function 370 have access to sensor data from various on-board vehicle sensors 360, upon which vehicle control may be based. These sensors may comprise, e.g., global positioning system (GPS) receivers, vision-based sensors, wheel speed sensors, radar sensors and/or lidar sensors. The sensors are, among other things, configured to determine a vehicle location in relation to a reference path.

The vehicle control based on a plurality of tracking points may be used in the TSM function 370 and/or in the VMM function 350. For example, the TSM function 370 may implement a path-following approach based on AFG, which provides an AFG velocity reference for each tracking point, the target acceleration value and the desired acceleration value for each tracking point may be determined by the TSM function 370, and the motion control may be performed by the VMM function 350. Typically, the TSM function 370 provides global virtual controls in the form of global desired acceleration elements (e.g., a desired longitudinal acceleration

$${a}_{x , G}^{d} ,$$

a desired lateral acceleration

$${a}_{y , G}^{d} ,$$

and a desired angular acceleration

$${\ddot{ψ}}_{j}^{d}$$

for each vehicle unit) to the VMM function 350. Also typically, the VMM function 350 performs control allocation by deriving global forces elements (e.g., a desired longitudinal force

$${F}_{x}^{d} ,$$

a desired lateral force

$${F}_{y}^{d} ,$$

and a desired moment

$${M}_{j}^{d}$$

for each vehicle unit) from the global desired acceleration elements, and using the global forces elements for MSD control. It should be understood that other splits between the TSM function and the VMM function are also possible. For example, the TSM function may provide the desired acceleration values

$${a}_{i}^{d}$$

per tracking point to the VMM function, and the VMM function may use them for control allocation (e.g., by transforming them to global desired acceleration elements, which are then used to determine global forces elements).

To this end, the steps of the method 200 of FIG. 2A may be performed by the TSM function 370 (or—possibly—by the TSM function 370 and the VMM function 350 together), according to some examples.

FIG. 4 schematically illustrates a simplified vehicle motion management (VMM) 450 according to some examples. For example, the VMM 450 may illustrate a possible implementation of the VMM function 350 of FIG. 3. Alternatively or additionally, the VMM 450 may be comprised in the vehicle control unit 190 of FIG. 1.

The VMM 450 comprises motion estimation 451, global force generation 452, and motion coordination 453.

The motion estimation 451 is configured to provide measured/estimated parameters 401 representing the current motion of the vehicle to the global force generation 452. For example, the parameters 401 may comprise one or more of: vertical force F_{z}, friction between road and tire μ (which may be used for slip detection), vehicle velocity in relation to a vehicle-centered coordinate system νₓ, road gradient (or road slope) α, and road banking β.

The global force generation 452 is configured to determine global forces elements ν (compare with sub-step 232 of the method 200 of FIG. 2) based on the parameters 401 representing the current motion of the vehicle and based on motion requests 411 (e.g., an acceleration request, such as information regarding the desired acceleration per tracking point from step 220 of the method 200 of FIG. 2). The global force generation 452 is also configured to provide the determined global forces elements 405 to the motion coordination 453.

The motion coordination 453 is configured to receive information 413 regarding the motion support devices of the vehicle. The motion coordination 453 is further configured to determine actuator request elements u based on the determined global forces elements ν and the information 413 regarding the motion support devices. The motion coordination 453 is also configured to provide information 414, including the actuator request elements u (e.g., based on V=BU, where V is a vector of global forces elements ν and U is a vector of actuator request elements μ), for operation of the plurality of motion support devices.

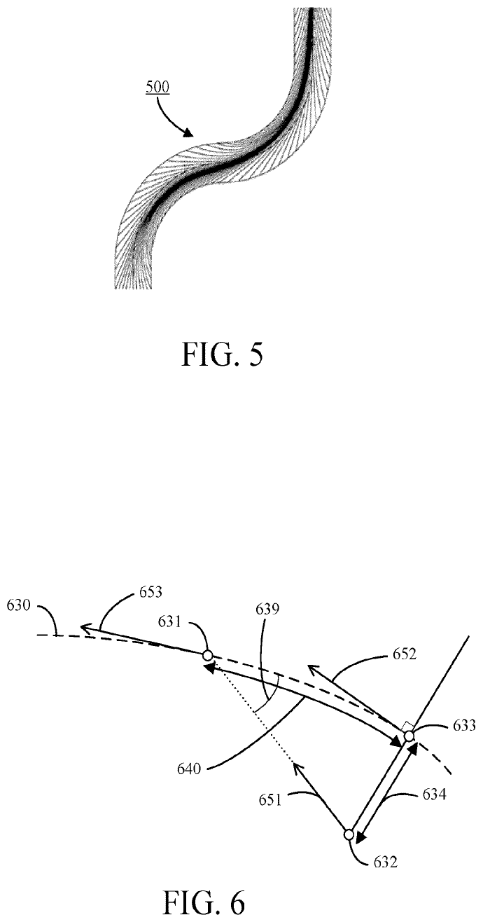

FIG. 5 schematically illustrates an example vector field 500 for path following based on vector field guidance, and FIG. 6 schematically illustrates some example principles of a path following approach based on vector field guidance. A general idea in relation to the vector field guidance approach may be seen as generating a vector field with location-specific guiding vectors, and controlling the vehicle according to the guiding vector at the current position 632 of the vehicle. One example of vector field guidance is artificial flow guidance (AFG).

In the illustration, the vehicle location 632 has a lateral offset 634 relative the reference path 630.

The applied path following approach includes steering—from the vehicle location 632—towards a goal point 631 on the reference path 630. The goal point 631 is distanced along the reference path 630 by a preview distance 640 measured from a reference location 633, which corresponds to an orthogonal projection of the vehicle location 632 on the reference path 630.

According to some examples, each tracking points in the plurality of tracking points is applied as a vehicle location 632, and a respective target acceleration is determined for each tracking point based on vector field guidance by assuming that the tracking point under consideration represents the vehicle location 632.

For example, the path following approach may comprise striving for that the tracking point under consideration should follow a location-specific guiding vector w (e.g., representing a target motion—such as a AFG velocity reference—at the location 632).

Generally, some path following approaches based on vector field guidance determines the location-specific guiding vector w based on one or more of: the vector 651 (which is specific to the location 632, and points towards the goal point 631), the vector 652 (which is specific to the reference location 633, and points along the tangent of the reference path 630), and the vector 653 (which is specific to the goal point 631, and points along the tangent of the reference path 630).

For example, a location-specific guiding vector w of a vector field may be determined such that it points from the location 632 at hand towards the goal point 631 on the reference path; e.g., w=t₃ where t₃ is a unit-length vector pointing directly towards the goal point for the location at hand (compare with 651 of FIG. 6). According to some examples, the direction of the location-specific guiding vector w is adjusted in dependence of the curvature of the reference path 630; e.g., to avoid ‘cutting corners/curves’. For example, the location-specific guiding vector w may be defined as

$$w = {t}_{3} + \frac{{t}_{1} - {t}_{2}}{2 cos θ} ,$$

where t₃ is a unit-length vector pointing directly towards the goal point for the location at hand (compare with 651 of FIG. 6), t₁ and t₂ are unit-length tangent vectors at the reference point and the goal point, respectively (compare with 652 and 653 of FIG. 6), and the angle θ corresponds to half the angle between t₁ and t₂. The term

$$\frac{{t}_{1} - {t}_{2}}{2 cos θ}$$

may be seen as a directional adjustment relating to reference path curvature; i.e., relating to the case t₁≠t₂.

Some exemplification will now be provided for transforming the desired acceleration values

$${a}_{i}^{d}$$

to desired global motion parameters for vehicle motion management (compare with sub-step 232 of FIG. 2).

As already mentioned, the global motion parameters may include global desired acceleration elements, such as a desired longitudinal acceleration

$${a}_{x , G}^{d}$$

(e.g., relating to a tractor unit), a desired lateral acceleration

$${a}_{y , G}^{d}$$

(e.g., relating to a tractor unit), and a desired angular acceleration

$${\ddot{ψ}}_{j}^{d}$$

for each vehicle unit, and/or global forces elements ν, such as a desired longitudinal force

$${F}_{x}^{d} ,$$

a desired lateral force

$${F}_{y}^{d} ,$$

and a desired moment

$${M}_{j}^{d}$$

for each vehicle unit.

The global desired acceleration elements may be arranged in a vector

$${\vec{V}}_{k} = [ \begin{matrix}{a}_{x , G}^{d} & {a}_{y , G}^{d} & {\ddot{ψ}}_{1}^{d} & {\ddot{ψ}}_{2}^{d} & {… ]}^{T}\end{matrix}$$

and the or global forces elements may be arranged in a vector

$$V = [ \begin{matrix}{F}_{x}^{d} & {F}_{y}^{d} & {M}_{1}^{d} & {M}_{2}^{d} & {… ]}^{T}\end{matrix} .$$

The vector V may be seen as a virtual control vector, which comprises ideal forces to be applied to a tractor vehicle and ideal moment(s) to be applied to the vehicle unit(s). The vector [symbol] may be seen as a kinematic vector, which comprises ideal acceleration for a tractor unit and ideal yaw acceleration(s) for the vehicle unit(s).

Typically the relation between global desired acceleration elements and global forces elements, which is commonly referred to as the equation of motion (EOM), may be expressed as V=M [symbol] (for single unit vehicles) or more generally as QV=M [symbol] +N (for multi-unit vehicles) where Q=I denotes the identity matrix.

For a single unit vehicle, the transform matrix may typically be defined as M=diag(m, m, I_{z}), wherein m denotes the mass (typically in kg) of the unit and I_{z} denotes the moment of inertia in a z-axis of the unit (the z-axis is typically a vertical axis through the center of rotation of the unit). For a multi-unit vehicle, the transform matrix typically becomes more elaborate (e.g., according to any suitable approach for determining a motion of equation for a multi-unit vehicle).

In some examples, the second term of the generalized EOM may be expressed as

$$N = C [ \begin{matrix}{v}_{x , G}^{d} & {v}_{y , G}^{d} & {\dot{ψ}}_{1}^{d} & {\dot{ψ}}_{2}^{d} & {… ]}^{T}\end{matrix} ,$$

where

$${v}_{x , G}^{d} and {v}_{y , G}^{d}$$

represents desired longitudinal and lateral velocities (e.g., relating to a tractor unit), and C is a matrix with all-zero elements in the first two columns.

Generally the desired acceleration values

$${a}_{i}^{d}$$

may be transformed to global desired acceleration elements

$$[ \begin{matrix}{a}_{x , G}^{d} & {a}_{y , G}^{d} & {\ddot{ψ}}_{1}^{d} & {\ddot{ψ}}_{2}^{d} & … ]\end{matrix}$$

in any suitable way.

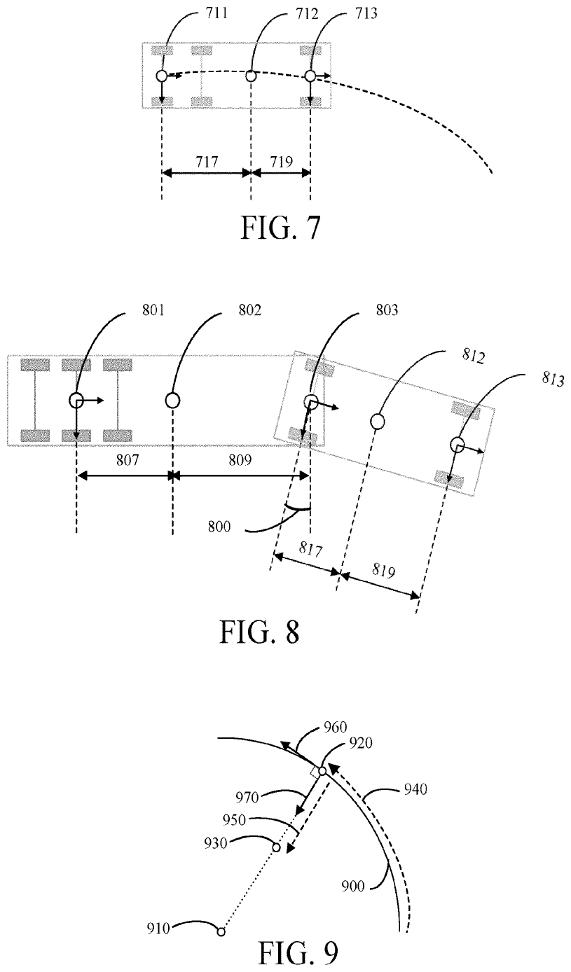

FIG. 7 schematically illustrates the principles of one transformation from desired acceleration values to global desired acceleration elements for a single unit vehicle with two tracking points 711, 713, and a yaw center of rotation 712. The distance 717 between the rear tracking point 711 and the center of rotation 712 is denoted by L₃, the distance 719 between the front tracking point 713 and the center of rotation 712 is denoted by L₁, and L=L₁+L₃.

The front tracking point 713 has an associated desired acceleration value

$${a}_{1}^{d} = [ \begin{matrix}{a}_{x , 1}^{d} & {a}_{y , 1}^{d}\end{matrix} ]$$

and the rear tracking point 711 has an associated desired acceleration value

$${a}_{2}^{d} = [ {a}_{x , 2}^{d} {a}_{y , 2}^{d} ] ,$$

wherein the elements are illustrated by arrows at each of the two tracking points 711, 713 in FIG. 7. Assuming that

$${a}_{x , 2}^{{}_{d}} = {a}_{x , 1}^{d}$$

the information represented by the desired acceleration elements may be collected in a vector

$${\vec{V}}_{f} = {[ {a}_{x , 1}^{d} {a}_{y , 1}^{d} {a}_{y , 2}^{d} ]}^{T} .$$

Using kinematics analysis, it may be shown that

$$\{ \begin{matrix}{a}_{x , G}^{d} = {a}_{x , 1}^{d} + {{L}_{1} ( {\dot{ψ}}_{1}^{{}_{d}} )}^{2} \\ {a}_{y , G}^{d} = ( {L}_{3} {a}_{y , 1}^{d} + {L}_{1} {a}_{y , 2}^{d} ) / L \\ {\ddot{ψ}}_{1}^{{}_{d}} = ( {a}_{y , 1}^{d} - {a}_{y , 2}^{d} ) / L\end{matrix}$$

which may be expressed as [symbol] =B_{f} [symbol] +C_{f}, with B_{f} and C_{f} defined according the equation system above; thereby defining a relationship between the desired acceleration values

$${a}_{i}^{d}$$

and the global desired acceleration elements

$${\vec{V}}_{k} = {[ {a}_{x , G}^{d} {a}_{y , G}^{d} {\ddot{ψ}}_{1}^{{}_{d}} ]}^{T} .$$

FIG. 8 schematically illustrates the principles of one transformation from desired acceleration values to global desired acceleration elements for a dual unit vehicle with three points 801, 803, 813, and respective yaw centers of rotation 802, 812 for the two vehicle units. The point 803 represents a connection point between the vehicle units, and may be an intermediate tracking point used for kinetically relating the tracking points 801, 813 to each other).

For the tractor unit, the distance 817 between the rear tracking point 803 and the center of rotation 812 is denoted by L_{3,A}, the distance 819 between the front tracking point 813 and the center of rotation 812 is denoted by L_{1,A}, and L_{A}=L_{1,A}+L_{3,A}. For the trailer unit, the distance 807 between the rear tracking point 801 and the center of rotation 802 is denoted by L_{3,B}, the distance 809 between the front tracking point 803 and the center of rotation 802 is denoted by L_{1,B}, and L_{B}=L_{1,B}+L_{3,B}. The angle 800 between the two vehicle units is denoted by θ.

Each tracking point 801, 803, 813 has an associated desired acceleration value

$${a}_{i}^{d} = [ {a}_{x , i}^{d} {a}_{y , i}^{d} ] , i = 1 , 2 , 3$$

wherein the elements are illustrated by arrows at each of the three tracking points in FIG. 8. Assuming, similarly as above, that

$${a}_{x , i}^{d} = {a}_{x , 1}^{d} , ∀ i ,$$

the information represented by the desired acceleration elements may be collected in a vector

$${\vec{V}}_{f} = {[ {a}_{x , 1}^{d} {a}_{y , 1}^{d} {a}_{y , 2}^{d} {a}_{y , 3}^{d} ]}^{T} .$$

Using kinematics analysis, it may be shown that

$$\{ \begin{matrix}{a}_{x , G}^{d} = {a}_{x , 1}^{d} + {{L}_{1 , A} ( {\dot{ψ}}_{1}^{{}_{d}} )}^{2} \\ {a}_{y , G}^{d} = ( {L}_{3 , A} {a}_{y , 1}^{d} + {L}_{1 , A} {a}_{y , 2}^{d} ) / {L}_{1 , A} \\ {\ddot{ψ}}_{1}^{{}_{d}} = ( {a}_{y , 1}^{d} - {a}_{y , 2}^{d} ) / {L}_{1 , A} \\ {\ddot{ψ}}_{2}^{{}_{d}} = ( {a}_{x , 1}^{d} sin θ + {a}_{y , 2}^{d} cos θ - {a}_{y , 3}^{d} + {{L}_{1 , A} ( {\dot{ψ}}_{1}^{{}_{d}} )}^{2} sin θ ) / {L}_{1 , B}\end{matrix}$$

which may be expressed as [symbol] =B_{f} [symbol] +C_{f}, with B_{f} and C_{f} defined according the equation system above; thereby defining a relationship between the desired acceleration values

$${a}_{i}^{d}$$

and the global desired acceleration elements

$${\vec{V}}_{k} = {[ {a}_{x , G}^{d} {a}_{y , G}^{d} {\ddot{ψ}}_{1}^{{}_{d}} {\ddot{ψ}}_{2}^{{}_{d}} ]}^{T} .$$

Generally, the information represented by the desired acceleration elements may be collected in a vector V_{f}, which contains a sufficient subset of the desired acceleration elements under structural constraints associated with the tracking points. Typically, there may be N longitudinal motion constraints

$$( e . g . , {a}_{x , i}^{d} = {a}_{x , i - 1}^{d} + {( {\dot{ψ}}_{1}^{{}_{d}} )}^{2} {L}_{i , i - 1 ,} ∀ i )$$

when there are N rigid vehicle units and N+1 tracking points, which enables a reduction in dimensionality from 2(N+1) desired acceleration elements to N+2 desired acceleration elements.

The above exemplified principles of transformation from desired acceleration values to global desired acceleration elements may be generally applied in the context of any vehicle combination, by properly extending the dimensionality and adapting the kinematics analysis.

FIG. 9 schematically illustrates a two-dimensional curvilinear coordinate system in relation to a reference path 900, which may be used for determining the flow acceleration α^{f} based on a gradient of the AFG velocity reference w at the tracking point (compare with sub-step 214 of FIG. 2). More particularly, a two-dimensional curvilinear coordinate system, wherein the AFG velocity reference is defended as \tilde{w}, may be used in relation to determining the derivative of the AFG velocity reference w.

It should be noted that the derivative of the AFG velocity reference may be determined in any suitable way, and the following approach is merely an example. According to the following approach, analytical determination of the derivative is enabled. This may be beneficial over using numerical differentiation, which may cause noise generation (e.g., by introducing errors) and/or require substantial computational time.

The two-dimensional curvilinear coordinate system is defined for a reference point 920 on the reference path 900. For example, the reference point may correspond to the reference location 633 in FIG. 6.

The curvilinear coordinate system has a first basis 960 along the reference path and a second basis 970 perpendicular to the first basis. Also represented in FIG. 9 is the lateral displacement s₂ 950 of the tracking point 930 from the reference point 920 (compare with 634 of FIG. 6) and longitudinal displacement s₁ 940 of the reference point 920 along the reference path 900.

In some examples, the magnitudes of the first and second bases are related by a scaling value γ in a Cartesian coordinate system. For example, the scaling value may be a function of an arc curvature K of the reference path 900 at the reference point 920 and/or on the lateral displacement s₂ 950. An example function is γ=1−κs₂, where κ=1/R and R is the distance from the reference point 920 to a curvature center of rotation 910.

Thus, the expansion/contraction caused by lateral deviations δx from the reference path 900 may be expressed via a displacement vector δx=γδs₁t+δs₂n, where t (compare with the first basis) is a unit tangent to the reference path 900 at the reference point 920, and n (compare with the second basis) is a unit normal to the reference path 900 at the reference point 920, pointing towards the curvature center of rotation 910. For |s₂|>0, the scaling value γ causes a distance contraction associated with δs₁. It should be noted that the vector x in δx indicates a position vector, which—generally—has longitudinal component and a lateral component.

To ensure application to both positive and negative values of s₂, σ=sign(s₂) may be introduced and the lateral displacement magnitude γ=σs₂ may be used instead of the lateral displacement s₂.

For small displacements (e.g., |δx|<trh), w=[w₁ w₂]^{T} in Cartesian coordinates and w=[w₁ V₂]T in curvilinear coordinates behave similarly so that w=Γ\tilde{w}₁t+\tilde{w}₂n.

In Cartesian coordinates, the coordinate directions e₁ and e₂ are fixed, w=w₁e₁+w₂e₂, and the flow acceleration may be determined as α^{f}=\dot{w}=\dot{w}₁e₁+\dot{w}₂e₂ (since the derivative of the fixed directions e₁ and e₂ is zero).

In curvilinear coordinates, this corresponds to

$$\dot{w} = γ {{w}^{\dot{\sim}}}_{1} t + {{w}^{\dot{\sim}}}_{2} n + \dot{γ} {\tilde{w}}_{1} t + γ {\tilde{w}}_{1} \dot{t} + {\tilde{w}}_{2} \dot{n} = ( γ {{w}^{\dot{\sim}}}_{1} - 2 κ {\tilde{w}}_{1} {\tilde{w}}_{2} ) t + ( {{w}^{\dot{\sim}}}_{2} + κγ {\tilde{w}}_{1}^{2} ) n ≡ {a}_{t} t + {a}_{n} n ,$$

where \dot{γ}=−κw₂ since κ is locally constant, and \dot{t}=κ\tilde{w}₁n and \dot{n}=−κ\tilde{w}₁t due to the locally circular motion along the arc of the reference path 900.

Approximating the speed along the target path to be constant (i.e., \tilde{w}₁=H for constant speed value H), and using the notation h=tan α where α represents the angle of attack from the tracking point 930 towards the reference path 900, it may be determined that \tilde{w}₂=−σHh, that \tilde{w}₂=−σHh′(γ)\dot{γ}=−σHh′σs₂=−Hh′\tilde{w}₂=−Hh′(−σHh)=σH²hh′, and that \dot{w}=2σκH²ht+(σH²hh′+κγH²)n. This analytical expression for the derivative of the AFG velocity reference w may be conveniently used when the flow acceleration is to be determined (compare with sub-step 214 of FIG. 2).

In some examples, the angle of attach α, and thereby h, may vary depending on the lateral displacement γ. For example, using minimum preview distance L₀(e.g., 3 meters), a maximum preview distance Lₘₐₓ (e.g., 25 meters), and some suitable constants a and b:

$$h = \{ \begin{matrix}y / {L}_{0} & if 0 \leq y < {y}_{0} \\ {H}^{- 1} \sqrt{2 ay + b} & if {y}_{0} \leq y < {y}_{1} \\ y / {L}_{max} & if {y}_{1} \leq y .\end{matrix}$$

FIG. 10 schematically illustrates an example apparatus 1000 for motion control of a vehicle based on artificial flow guidance (AFG) in relation to a reference path (compare with the method 200 of FIG. 2).

For example, the apparatus 1000 may be configured to perform, or cause performance of, one of more steps as described in connection with FIG. 2. Alternatively or additionally, the apparatus 1000 may be comprised, or comprisable, in an on-board vehicle control unit 1010 (e.g., the VCU 190 of FIG. 1).

The apparatus 1000 comprises a controller (CNTR; e.g., controlling circuitry or a control module) 1020.

In some examples, the controller 1020 may comprise, or be otherwise associated with (e.g., connected, or connectable, to) an interface (IF) 1030, for communication with one or more other functions (e.g., an AFG function and/or a VMM function).

The controller 1020 is configured to cause use of AFG to determine a target acceleration value for each tracking point of a plurality of tracking points defined in relation to the vehicle (compare with step 210 of FIG. 2). To this end, the controller 1020 may comprise, or be otherwise associated with (e.g., connected, or connectable, to) a target acceleration determiner (TAD; e.g., determining circuitry or a determination module) 1021. The target acceleration determiner 1021 may be configured to use AFG to determine the target acceleration values.

The controller 1020 is also configured to cause determination of a desired acceleration value for each tracking point based on the target acceleration values and on a structural constraint between the tracking points (compare with step 220 of FIG. 2). To this end, the controller 1020 may comprise, or be otherwise associated with (e.g., connected, or connectable, to) a desired acceleration determiner (DAD; e.g., determining circuitry or a determination module) 1022. The desired acceleration determiner 1022 may be configured to determine the desired acceleration values.

The controller 1020 is also configured to cause motion control of the vehicle based on the desired acceleration values (compare with step 230 of FIG. 2). To this end, the controller 1020 may comprise, or be otherwise associated with (e.g., connected, or connectable, to) a motion controller (MC; e.g., a VMM function) 1023. The motion controller 1023 may be configured to perform motion control based on the desired acceleration values. Alternatively, the controller 1020 may be configured to provide the desired acceleration values to an external motion controller via the interface 1030.

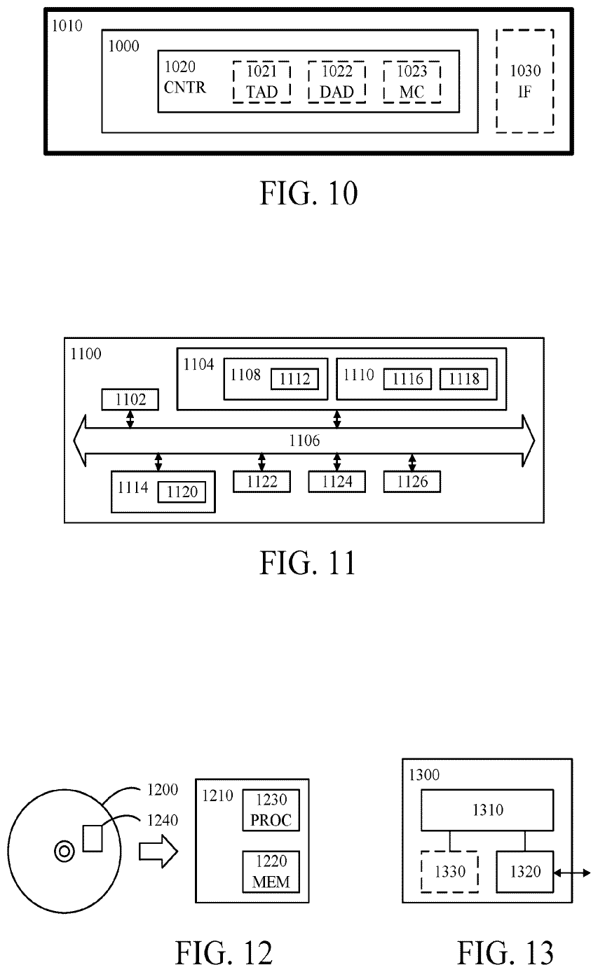

FIG. 11 is a schematic diagram of a computer system 1100 for implementing examples disclosed herein. The computer system 1100 is adapted to execute instructions from a computer-readable medium to perform these and/or any of the functions or processing described herein. The computer system 1100 may be connected (e.g., networked) to other machines in a LAN, an intranet, an extranet, or the Internet. While only a single device is illustrated, the computer system 1100 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 1100 may comprise at least one computing device or electronic device capable of including firmware, hardware, and/or executing software instructions to implement the functionality described herein. The computer system 1100 may include processing circuitry 1102 (e.g., processing circuitry including one or more processor devices or control units), a memory 1104, and a system bus 1106. The computer system 1100 may include at least one computing device having the processing circuitry 1102. The system bus 1106 provides an interface for system components including, but not limited to, the memory 1104 and the processing circuitry 1102. The processing circuitry 1102 may include any number of hardware components for conducting data or signal processing or for executing computer code stored in memory 1104. The processing circuitry 1102 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 1102 may further include computer executable code that controls operation of the programmable device.

The system bus 1106 may be any of several types of bus structures that may further interconnect to a memory bus (with or without a memory controller), a peripheral bus, and/or a local bus using any of a variety of bus architectures. The memory 1104 may be one or more devices for storing data and/or computer code for completing or facilitating methods described herein. The memory 1104 may include database components, object code components, script components, or other types of information structure for supporting the various activities herein. Any distributed or local memory device may be utilized with the systems and methods of this description. The memory 1104 may be communicably connected to the processing circuitry 1102 (e.g., via a circuit or any other wired, wireless, or network connection) and may include computer code for executing one or more processes described herein. The memory 1104 may include non-volatile memory 1108 (e.g., read-only memory (ROM), erasable programmable read-only memory (EPROM), electrically erasable programmable read-only memory (EEPROM), etc.), and volatile memory 1110 (e.g., random-access memory (RAM)), or any other medium which can be used to carry or store desired program code in the form of machine-executable instructions or data structures and which can be accessed by a computer or other machine with processing circuitry 1102. A basic input/output system (BIOS) 1112 may be stored in the non-volatile memory 1108 and can include the basic routines that help to transfer information between elements within the computer system 1100.

The computer system 1100 may further include or be coupled to a non-transitory computer-readable storage medium such as the storage device 1114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1114 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 1114 and/or in the volatile memory 1110, which may include an operating system 1116 and/or one or more program modules 1118. All or a portion of the examples disclosed herein may be implemented as a computer program 1120 stored on a transitory or non-transitory computer-usable or computer-readable storage medium (e.g., single medium or multiple media), such as the storage device 1114, which includes complex programming instructions (e.g., complex computer-readable program code) to cause the processing circuitry 1102 to carry out actions described herein. Thus, the computer-readable program code of the computer program 1120 can comprise software instructions for implementing the functionality of the examples described herein when executed by the processing circuitry 1102. In some examples, the storage device 1114 may be a computer program product (e.g., readable storage medium) storing the computer program 1120 thereon, where at least a portion of a computer program 1120 may be loadable (e.g., into a processor) for implementing the functionality of the examples described herein when executed by the processing circuitry 1102. The processing circuitry 1102 may serve as a controller or control system for the computer system 1100 that is to implement the functionality described herein.

The computer system 1100 may include an input device interface 1122 configured to receive input and selections to be communicated to the computer system 1100 when executing instructions, such as from a keyboard, mouse, touch-sensitive surface, etc. Such input devices may be connected to the processing circuitry 1102 through the input device interface 1122 coupled to the system bus 1106 but can be connected through other interfaces, such as a parallel port, an Institute of Electrical and Electronic Engineers (IEEE) 1394 serial port, a Universal Serial Bus (USB) port, an IR interface, and the like. The computer system 1100 may include an output device interface 1124 configured to forward output, such as to a display, a video display unit (e.g., a liquid crystal display (LCD) or a cathode ray tube (CRT)). The computer system 1100 may include a communications interface 1126 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The described examples and their equivalents may be realized in software or hardware or a combination thereof. The examples may be performed by general purpose circuitry. Examples of general purpose circuitry include digital signal processors (DSP), central processing units (CPU), co-processor units, field programmable gate arrays (FPGA) and other programmable hardware. Alternatively or additionally, the examples may be performed by specialized circuitry, such as application specific integrated circuits (ASIC). The general purpose circuitry and/or the specialized circuitry may, for example, be associated with or comprised in an electronic apparatus such as a vehicle control unit.

The electronic apparatus may comprise arrangements, circuitry, and/or logic according to any of the examples described herein. Alternatively or additionally, the electronic apparatus may be configured to perform method steps according to any of the examples described herein.

According to some examples, a computer program product comprises a non-transitory computer readable medium such as, for example, a universal serial bus (USB) memory, a plug-in card, an embedded drive, or a read only memory (ROM). FIG. 12 illustrates an example computer readable medium in the form of a compact disc (CD) ROM 1200. The computer readable medium has stored thereon a computer program 1240 comprising program instructions. The computer program is loadable into a data processor (e.g., a data processing unit) 1220, which may, for example, be comprised in a vehicle control unit 1210. When loaded into the data processor, the computer program may be stored in a memory 1230 associated with, or comprised in, the data processor. According to some examples, the computer program may, when loaded into, and run by, the data processor, cause execution of method steps according to, for example, any of the methods described herein.

FIG. 13 schematically illustrates, in terms of a number of functional units, the components of a control unit 1300 according to some examples. The control unit may be comprised in a vehicle, e.g., in the form of a vehicle control unit. A processor device in the form of processing circuitry 1310 is provided using any combination of one or more of a suitable central processing unit (CPU), multiprocessor, microcontroller, digital signal processor (DSP), or similar; capable of executing software instructions stored in a computer program product, e.g. in the form of a storage medium 1330. The processing circuitry 1310 may further be provided as at least one application specific integrated circuit ASIC, or field programmable gate array FPGA.

Particularly, the processing circuitry 1310 is configured to cause the control unit 1300 to perform a set of operations, or steps; for example, the method discussed in connection to FIG. 2.

For example, the storage medium 1330 may store a set of operations, and the processing circuitry 1310 may be configured to retrieve the set of operations from the storage medium 1330 to cause the control unit 1300 to perform the set of operations. The set of operations may be provided as a set of executable instructions. Thus, the processing circuitry 1310 is thereby arranged to execute method steps as herein disclosed.

The storage medium 1330 may comprise persistent storage, which, for example, can be any single one or combination of magnetic memory, optical memory, solid state memory or even remotely mounted memory.

The control unit 1300 may further comprise an interface 1320 for communication with at least one external device. As such, the interface 1320 may comprise one or more transmitters and receivers, comprising analogue and digital components and a suitable number of ports for wireline or wireless communication.

The processing circuitry 1310 controls the general operation of the control unit 1300, e.g., by sending data and control signals to the interface 1320 and the storage medium 1330, by receiving data and reports from the interface 1320, and by retrieving data and instructions from the storage medium 1330. Other components, as well as the related functionality, of the control node are omitted in order not to obscure the concepts presented herein.

In some examples, the control unit 1300 may be seen as a control system, or may be comprised in a control system. Such a control system may, for example, comprise the apparatus 1000 as described in connection with FIG. 10 (e.g., the processing circuitry 1310 may comprise the controller 1020 of FIG. 10).

The control system may be configured to perform or cause vehicle motion management as described herein.

For example, the VCU 190 of FIG. 1 may comprise one or more of the apparatus 1000 of FIG. 10, the control system 1010 of FIG. 10, the computer system 1100 of FIG. 11, the vehicle control unit 1210 of FIG. 12, and the control unit 1300 of FIG. 13.

It should be noted that features and/or advantages described herein in connection with one of the Figures, may be equally applicable—mutatis mutandis—in the context of one or more of the other Figures, even if not explicitly mentioned herein in connection with that other Figure(s).

The following is a list of some examples in relation to this disclosure:

Example 1: A computer system for motion control of a vehicle based on artificial flow guidance, AFG, in relation to a reference path, wherein a plurality of tracking points are defined in relation to the vehicle, the computer system comprising processing circuitry configured to: use AFG to determine a target acceleration value for each tracking point; determine a desired acceleration value for each tracking point based on the target acceleration values and on a structural constraint between the tracking points; and cause motion control of the vehicle based on the desired acceleration values.

Example 2: The computer system of example 1, wherein the processing circuitry is configured to cause the motion control of the vehicle by transforming the desired acceleration values to desired global motion parameters for vehicle motion management.

Example 3: The computer system of any of examples 1 through 2, wherein the processing circuitry is configured to determine the desired acceleration values sequentially, starting from a specific one of the tracking points in an initial determination step, wherein the initial determination step comprises determining the desired acceleration value of the specific tracking point as the target acceleration value for the specific tracking point, and wherein each further determination step comprises determining the desired acceleration value of a considered one of the tracking points based on the target acceleration value for the considered tracking point, the desired acceleration value determined for a respective tracking point in a previous determination step, and the structural constraint between the respective tracking point and the considered tracking point.

Example 4: The computer system of example 3, wherein each target acceleration value relates to a target speed and a target curvature, wherein the initial determination step is conditioned on compliance with target speed and target curvature for the specific tracking point, and wherein each further determination step is conditioned on compliance with target curvature for the considered tracking point.

Example 5: The computer system of any of examples 1 through 4, wherein the processing circuitry is configured to determine the target acceleration value of a particular tracking point by acquiring an AFG velocity reference for the particular tracking point, and determining a flow acceleration for the particular tracking point based on a gradient of the AFG velocity reference at the particular tracking point.

Example 6: The computer system of example 5, wherein the processing circuitry is configured to determine the gradient of the AFG velocity reference by application of a two-dimensional curvilinear coordinate system defined for a reference point on the reference path.

Example 7: The computer system of example 6, wherein the curvilinear coordinate system has a first basis along the reference path and a second basis perpendicular to the first basis, and wherein magnitudes of the first and second bases are related by a scaling value in a Cartesian coordinate system.

Example 8: The computer system of example 7, wherein the scaling value is a function of an arc curvature of the reference path at the reference point and on a lateral displacement of the particular tracking point from the reference point.

Example 9: The computer system of any of examples 5 through 8, wherein the processing circuitry is configured to determine the target acceleration value of a particular tracking point by adjusting the flow acceleration for the particular tracking point using AFG feedback.

Example 10: The computer system of example 9, wherein the processing circuitry is configured to limit the AFG feedback by application of an AFG feedback saturation threshold.

Example 11: The computer system of any of examples 1 through 10, wherein the processing circuitry is configured to limit the target acceleration value by application of a target acceleration saturation threshold.

Example 12: A vehicle comprising the computer system of any of examples 1 through 11.

Example 13: A computer-implemented method for motion control of a vehicle based on artificial flow guidance, AFG, in relation to a reference path, wherein a plurality of tracking points are defined in relation to the vehicle, the method comprising: using, by processing circuitry of a computer system, AFG to determine a target acceleration value for each tracking point; determining, by the processing circuitry, a desired acceleration value for each tracking point based on the target acceleration values and on a structural constraint between the tracking points; and causing, by the processing circuitry, motion control of the vehicle based on the desired acceleration values.

Example 14: The method of example 13, wherein causing the motion control of the vehicle comprises transforming the desired acceleration values to desired global motion parameters for vehicle motion management.

Example 15: The method of any of examples 13 through 14, wherein the desired acceleration values are determined sequentially, starting from a specific one of the tracking points in an initial determination step, wherein the initial determination step comprises determining the desired acceleration value of the specific tracking point as the target acceleration value for the specific tracking point, and wherein each further determination step comprises determining the desired acceleration value of a considered one of the tracking points based on the target acceleration value for the considered tracking point, the desired acceleration value determined for a respective tracking point in a previous determination step, and the structural constraint between the respective tracking point and the considered tracking point.

Example 16: The method of example 15, wherein each target acceleration value relates to a target speed and a target curvature, wherein the initial determination step is conditioned on compliance with target speed and target curvature for the specific tracking point, and wherein each further determination step is conditioned on compliance with target curvature for the considered tracking point.

Example 17: The method of any of examples 13 through 16, wherein the target acceleration value of a particular tracking point is determined by acquiring an AFG velocity reference for the particular tracking point, and determining a flow acceleration for the particular tracking point based on a gradient of the AFG velocity reference at the particular tracking point.

Example 18: The method of example 17, wherein determining the gradient of the AFG velocity reference comprises application of a two-dimensional curvilinear coordinate system defined for a reference point on the reference path.

Example 19: The method of example 18, wherein the curvilinear coordinate system has a first basis along the reference path and a second basis perpendicular to the first basis, and wherein magnitudes of the first and second bases are related by a scaling value in a Cartesian coordinate system.

Example 20: The method of example 19, wherein the scaling value is a function of an arc curvature of the reference path at the reference point and on a lateral displacement of the particular tracking point from the reference point.

Example 21: The method of any of examples 17 through 20, wherein the target acceleration value of a particular tracking point is determined by adjusting the flow acceleration for the particular tracking point using AFG feedback.

Example 22: The method of example 21, further comprising limiting the AFG feedback by application of an AFG feedback saturation threshold.

Example 23: The method of any of examples 13 through 22, further comprising limiting the target acceleration value by application of a target acceleration saturation threshold.

Example 24: A computer program product comprising program code for performing, when executed by the processing circuitry, the method of any of examples 13 through 23.

Example 25: A non-transitory computer-readable storage medium comprising instructions, which when executed by the processing circuitry, cause the processing circuitry to perform the method of any of examples 13 through 23.

Example 26: An apparatus for motion control of a vehicle based on artificial flow guidance, AFG, in relation to a reference path, wherein a plurality of tracking points are defined in relation to the vehicle, the apparatus comprising controlling circuitry configured to cause: use of AFG to determine a target acceleration value for each tracking point; determination of a desired acceleration value for each tracking point based on the target acceleration values and on a structural constraint between the tracking points; and motion control of the vehicle to be performed based on the desired acceleration values.

Example 27: The apparatus of example 26, wherein the controlling circuitry is configured to cause motion control of the vehicle by causing transformation of the desired acceleration values to desired global motion parameters for vehicle motion management.

Example 28: The apparatus of any of examples 26 through 27, wherein the controlling circuitry is configured to cause the desired acceleration values to be determined sequentially, starting from a specific one of the tracking points in an initial determination step, wherein the initial determination step comprises determination of the desired acceleration value of the specific tracking point as the target acceleration value for the specific tracking point, and wherein each further determination step comprises determination of the desired acceleration value of a considered one of the tracking points based on the target acceleration value for the considered tracking point, the desired acceleration value determined for a respective tracking point in a previous determination step, and the structural constraint between the respective tracking point and the considered tracking point.

Example 29: The apparatus of example 28, wherein each target acceleration value relates to a target speed and a target curvature, wherein the initial determination step is conditioned on compliance with target speed and target curvature for the specific tracking point, and wherein each further determination step is conditioned on compliance with target curvature for the considered tracking point.

Example 30: The apparatus of any of examples 26 through 29, wherein the controlling circuitry is configured to cause the target acceleration value of a particular tracking point to be determined by acquisition of an AFG velocity reference for the particular tracking point, and determination of a flow acceleration for the particular tracking point based on a gradient of the AFG velocity reference at the particular tracking point.

Example 31: The apparatus of example 30, wherein the controlling circuitry is configured to cause the gradient of the AFG velocity reference to be determined by application of a two-dimensional curvilinear coordinate system defined for a reference point on the reference path.

Example 32: The apparatus of example 31, wherein the curvilinear coordinate system has a first basis along the reference path and a second basis perpendicular to the first basis, and wherein magnitudes of the first and second bases are related by a scaling value in a Cartesian coordinate system.

Example 33: The apparatus of example 32, wherein the scaling value is a function of an arc curvature of the reference path at the reference point and on a lateral displacement of the particular tracking point from the reference point.

Example 34: The apparatus of any of examples 30 through 33, wherein the controlling circuitry is configured to cause the target acceleration value of a particular tracking point to be determined by adjustment of the flow acceleration for the particular tracking point using AFG feedback.

Example 35: The apparatus of example 34, wherein the controlling circuitry is further configured to cause limitation of the AFG feedback by application of an AFG feedback saturation threshold.

Example 36: The apparatus of any of examples 26 through 35, wherein the controlling circuitry is further configured to cause limitation of the target acceleration value by application of a target acceleration saturation threshold.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

Reference has been made herein to various examples. However, a person skilled in the art would recognize numerous variations to the described examples that would still fall within the scope of the claims.

For example, the methods described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the examples disclosed herein may be applied to any other example, wherever suitable. Likewise, any advantage of any of the examples may apply to any other examples.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer system for motion control of a vehicle based on artificial flow guidance, AFG, in relation to a reference path, wherein a plurality of tracking points are defined in relation to the vehicle, the computer system comprising processing circuitry configured to:
use AFG to determine a target acceleration value for each tracking point;
determine a desired acceleration value for each tracking point based on the target acceleration values and on a structural constraint between the tracking points; and
cause motion control of the vehicle based on the desired acceleration values.

2. The computer system of claim 1, wherein the processing circuitry is configured to cause the motion control of the vehicle by transforming the desired acceleration values to desired global motion parameters for vehicle motion management.

3. The computer system of claim 1, wherein the processing circuitry is configured to determine the desired acceleration values sequentially, starting from a specific one of the tracking points in an initial determination step,
wherein the initial determination step comprises determining the desired acceleration value of the specific tracking point as the target acceleration value for the specific tracking point, and
wherein each further determination step comprises determining the desired acceleration value of a considered one of the tracking points based on the target acceleration value for the considered tracking point, the desired acceleration value determined for a respective tracking point in a previous determination step, and the structural constraint between the respective tracking point and the considered tracking point.

4. The computer system of claim 3, wherein each target acceleration value relates to a target speed and a target curvature, wherein the initial determination step is conditioned on compliance with target speed and target curvature for the specific tracking point, and wherein each further determination step is conditioned on compliance with target curvature for the considered tracking point.

5. The computer system of claim 1, wherein the processing circuitry is configured to determine the target acceleration value of a particular tracking point by acquiring an AFG velocity reference for the particular tracking point, and determining a flow acceleration for the particular tracking point based on a gradient of the AFG velocity reference at the particular tracking point.

6. The computer system of claim 5, wherein the processing circuitry is configured to determine the gradient of the AFG velocity reference by application of a two-dimensional curvilinear coordinate system defined for a reference point on the reference path.

7. The computer system of claim 6, wherein the curvilinear coordinate system has a first basis along the reference path and a second basis perpendicular to the first basis, and wherein magnitudes of the first and second bases are related by a scaling value in a Cartesian coordinate system.

8. The computer system of claim 7, wherein the scaling value is a function of an arc curvature of the reference path at the reference point and on a lateral displacement of the particular tracking point from the reference point.

9. The computer system of claim 5, wherein the processing circuitry is configured to determine the target acceleration value of a particular tracking point by adjusting the flow acceleration for the particular tracking point using feedback indicating an acceleration error.

10. The computer system of claim 9, wherein the processing circuitry is configured to limit the feedback by application of a feedback saturation threshold.

11. The computer system of claim 1, wherein the processing circuitry is configured to limit the target acceleration value by application of a target acceleration saturation threshold.

12. A vehicle comprising the computer system of claim 1.

13. A computer-implemented method for motion control of a vehicle based on artificial flow guidance, AFG, in relation to a reference path, wherein a plurality of tracking points are defined in relation to the vehicle, the method comprising:
using, by processing circuitry of a computer system, AFG to determine a target acceleration value for each tracking point;
determining, by the processing circuitry, a desired acceleration value for each tracking point based on the target acceleration values and on a structural constraint between the tracking points; and
causing, by the processing circuitry, motion control of the vehicle based on the desired acceleration values.

14. A computer program product comprising program code for performing, when executed by the processing circuitry, the method of claim 13.

15. A non-transitory computer-readable storage medium comprising instructions, which when executed by the processing circuitry, cause the processing circuitry to perform the method of claim 13.
